(19) United States
(12) Patent Application Publication
(10) Pub. No.: US 2013/0101072 A1
(43) Pub. Date: Apr. 25, 2013

(54) APPARATUS AND METHOD FOR EFFICIENT DIGITAL BROADCASTING BASED ON SINGLE FREQUENCY NETWORK

(71) Applicant: ELECTRONICS AND TELECOMMUNICATIONS R, Daejeon-si (KR)

(72) Inventors: Kwan Woong RYU, Daejeon-si (KR); Heung Mook KIM, Daejeon-si (KR); Nam Ho HUR, Daejeon-si (KR)

(73) Assignee: ELECTRONICS AND TELECOMMUNICATIONS RESEARCH INSTITUTE, Daejeon-si (KR)

(21) Appl. No.: 13/659,129

(22) Filed: Oct. 24, 2012

(30) Foreign Application Priority Data
Oct. 24, 2011 (KR) 10-2011-0108883
Oct. 23, 2012 (KR) 10-2012-0117741

(51) Int. Cl. H04L 27/38

(52) U.S. Cl. 375/340

(57) ABSTRACT

The present invention relates to an apparatus and method for simultaneous channel estimation in a digital broadcast system based on a single frequency network

The present specification encloses a receiver simultaneously acquiring channel responses for each subchannels including a certain number of pilot subcarriers in the frequency and time domain direction from frames transmitted with at least one signal

In the present invention, a receiving apparatus in the single frequency broadcast network may simultaneously estimate the channels of adjacent transmitters, and receiving CNR is enhanced by detecting MIMO signal by the estimated channel.

### CROSS-REFERENCE TO RELATED APPLICATIONS

Priority to Korean patent application numbers 10-2011-0108883 filed on Oct. 24, 2011 and 10-2012-0117741 filed on Oct. 23, 2012, the entire disclosure of which is incorporated by reference herein, is claimed.

### BACKGROUND OF THE INVENTION

1. Field of the Invention

The present invention relates to a digital broadcast system, more particularly, to an apparatus and method for efficient digital broadcasting based on a single frequency network.

2. Discussion of the Related Art

A digital broadcast network is largely classified into a multiple frequency network (MFN) and a single frequency network (SFN). The MFN, that is inefficient in terms of frequency use, is a scheme configuring a broadcast network so that frequencies different from each other are allocated into each transmitter or repeater. On the other hand, the SFN is that one frequency is allocated into the transmitter and repeater and the transmitter and repeater transmit signal by one frequency. Therefore, it is possible to enhance the use efficiency of the frequency and to ensure the strength of stable radio waves in a broadcasting service area. Transmitting requirements such as the same information, the same transmitting frequency and the same time is required to configure the SFN.

In recent, the SFN network is emerging as an important technology for the digital broadcast. All the existing digital broadcast services direct the services through the SFN, and the configuration of the SFN for next-generation broadcast is considered as one core technology. However, a next-generation digital broadcast system processes various information and should meet technological requirements to be transmitted while surpassing simple broadcast services provided by the previous-generation digital broadcast systems. In this situation, a prior SFN is available on the general-purpose broadcast service, but is not suited for the local broadcast service. Therefore, the digital broadcast system may increase coverage by enhancing receiving performance of the SFN, and requires a method and apparatus capable of performing the local broadcast service.

### SUMMARY OF THE INVENTION

An advantage of some aspect of the invention is that it provides an apparatus and method for selecting general-broadcast and local broadcast.

Another advantage of some aspect of the invention is that it provides an apparatus and method of selecting subchannels commonly applying channel estimation in the digital broadcast system based on the single frequency network.

Further advantage of some aspect of the invention is that it provides an apparatus and method of separating a signal by using a simultaneous channel estimation and MIMO receiver in a digital broadcasting system.

According to an aspect of the invention, there is provided a receiver for selecting a general-purpose broadcast and local broadcast in a digital broadcast system based on a single frequency network.

The receiver includes a RF receiving portion configured to receive at least one signals transmitted by at least one transmitter, a guard period removing portion configured to remove a guard period from the receiving signal inputted from the RF receiving portion, a serial/parallel transforming portion configured to transform the received signal into many paratactic subcarriers, a fast Fourier transforming portion configured to apply a fast Fourier transformation to the many paratactic subcarriers in the frequency domain, a pilot extracting portion configured to extract pilots from the signal transformed by the fast Fourier transform, and a general-purpose/local broadcast selecting portion configured to combine the at least one signal to output the general-purpose broadcast, and selecting any one of the at least one signal to output the local broadcast.

The receiver may further include a simultaneous channel estimating portion configured to simultaneously acquire channel responses for each subchannel including a certain number of pilot subcarriers in the frequency and time domain direction from frames transmitted with the at least one signal.

The simultaneous channel estimating portion may acquire the channel responses for each of a plurality of receiving antennas disposed in the receiver, and the receiver may further includes a MIMO detecting portion separately detecting the at least one signals using a spatial multiplexing MIMO signal detection scheme based on the channel responses for each of the plurality of receiving antennas.

The simultaneous channel estimating portion may select the subchannels having time smaller than coherence time in the time domain, and select the subchannels having frequency smaller than coherence frequency in the frequency domain.

The channel responses may be represented as a channel matrix configured with the channels experienced by the pilots included in the subchannels, and when an inverse matrix for the channel matrix is absent, the simultaneous channel estimating portion acquires the channel responses by time and frequency interpolation.

According to another aspect of the invention, there is provided a method for selecting a general-purpose broadcast and a local broadcast by a receiver in a digital broadcast system based on a single frequency network.

The method includes receiving at least one signals transmitted by at least one transmitter, removing a guard period from the receiving signal inputted from the RF receiving portion, transforming the received signal into many paratactic subcarriers, applying a fast Fourier transform to the many paratactic subcarriers in the frequency domain, extracting the pilots from the signal transformed by the fast Fourier transform, and combining the at least one signal to output the general-purpose broadcast, and selecting any one of the at least one signal to output the local broadcast.

The method may further include acquiring channel responses simultaneously for each subchannel including a certain number of pilot subcarriers in the frequency and time domain direction from frames transmitted with the at least one signal.

The channel responses may be the channel responses for each of a plurality of receiving antennas disposed in the receiver, and the method may further include separately detecting the at least one signals using a spatial multiplexing MIMO signal detection scheme based on the channel responses for each of the plurality of receiving antennas.

The method may further include selecting the subchannels having time smaller than coherence time in the time domain, and selecting the subchannels having frequency smaller than coherence frequency in the frequency domain.

The channel responses may be represented as a channel matrix configured with the channels experienced by the pilots included in the subchannels, and when an inverse matrix for the channel matrix is absent, the simultaneous channel estimating portion acquires the channel responses by time and frequency interpolation.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is an example of a layout for a digital broadcast network based on a SFN applying the present invention.

FIG. 2 is a block view showing the transmitter of the digital broadcast system according to an example of the present invention.

FIG. 3 is a block view showing the receiver of the digital broadcast system according to an example of the present invention.

FIG. 4 shows a frame structure of the digital broadcast system applying the present invention.

FIG. 5 is a flow chart showing a simultaneous channel estimating process and a broadcast selecting process in a digital broadcast receiver according to an example of the present invention.

### DETAILED DESCRIPTION OF THE EMBODIMENTS

Hereinafter, exemplary embodiments of the present invention will be described in detail with reference to the accompanying drawings. It is to be noted that in giving reference numerals to components of each of the accompanying drawing, like reference numerals refer to like elements even though the like components are shown in different drawings. Further, in describing exemplary embodiments of the present invention, well-known functions or constructions will not be described in detail since they may unnecessarily obscure the understanding of the present invention.

In addition, in describing components of the present specification, terms such as first, second, A, B, (a), (b), etc. may be used. These terms are used only to differentiate the components from other components. Therefore, the nature, times, sequence, etc. of the corresponding components are not limited by these terms. When any components are “connected”, “coupled”, or “linked” to other components, it is to be noted that the components may be directly connected or linked to other components, but the components may be “connected”, “coupled”, or “linked” to other components via another component therebetween.

Further, the present specification describes a digital broadcast network, operations that are performed in the digital broadcast network are performed by a process that controls a network and transmits data in the system (for example, a base station) managing the corresponding digital broadcast network, or the operations may be performed in a terminal coupled with the corresponding wireless network.

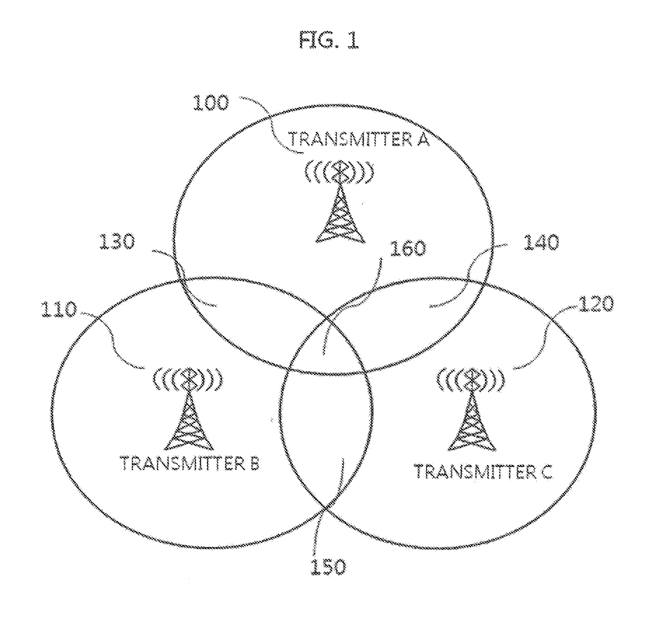

FIG. 1 is an example of a layout for a digital broadcast network based on a SFN applying the present invention.

Referring to FIG. 1, 3 transmitters transmitting the signal using the same frequency in the digital broadcast network are illustrated. Signal overlap is caused in the case that a transmitter A 100, a transmitter B 110 and a transmitter C 120 transmit the signal by a single frequency, and each signal overlap region is represented as follows. A signal overlap region AB 130 is the region that causes the signal overlap on simultaneously transmitting each of the signals of the transmitter A 100 and the transmitter B 110, a signal overlap region AC 140 is the region that causes the signal overlap on simultaneously transmitting each of the signals of the transmitter A 100 and the transmitter C 120, and a signal overlap region BC 150 is the region that causes the signal overlap on simultaneously transmitting each of the signals of the transmitter B 110 and the transmitter C 120. In addition, a signal overlap region ABC 160 is the region that causes the signal overlap on simultaneously transmitting each of the signals of the transmitter A 100, the transmitter B 110 and the transmitter C 120.

When the transmitter A 100, the transmitter B 110 and the transmitter C 120 transmit the same information at the same time and transmitting frequency on configuring the digital broadcast network by the SFN, the use efficiency for radio waves is increased. However, when each of the transmitter A 100, the transmitter B 110 and the transmitter C 120 should transmit information different from each other for a local broadcast, there is a problem capable of not using the existing SFN. Therefore, a broadcasting receiver should perform the simultaneous channel estimation and detection function to distinguish the signals of each transmitter. Therefore, receiving performance is enhanced and the local broadcast may be made possible at each transmitter.

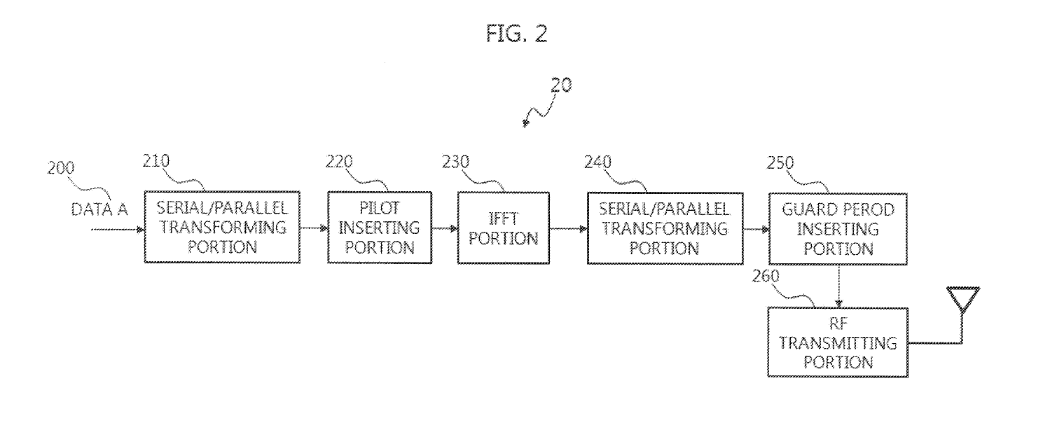

FIG. 2 is a block view showing the transmitter of the digital broadcast system according to an example of the present invention.

Referring to FIG. 2, a digital broadcast transmitter 20 includes transmitting data A 200, a pilot inserting portion 220 inserting pilots to be used on estimating channels experienced in the process transmitting the transmitting data A 200, an inverse fast Fourier transforming portion 230 (hereinafter, refer to an IFFT) transforming the signal in the frequency domain inserted with the pilots into the signal in the time domain by an inverse fast Fourier transformation, a parallel/serial transforming portion 240, a guard period inserting portion 250 and a radio frequency (RF) transmitting portion 260.

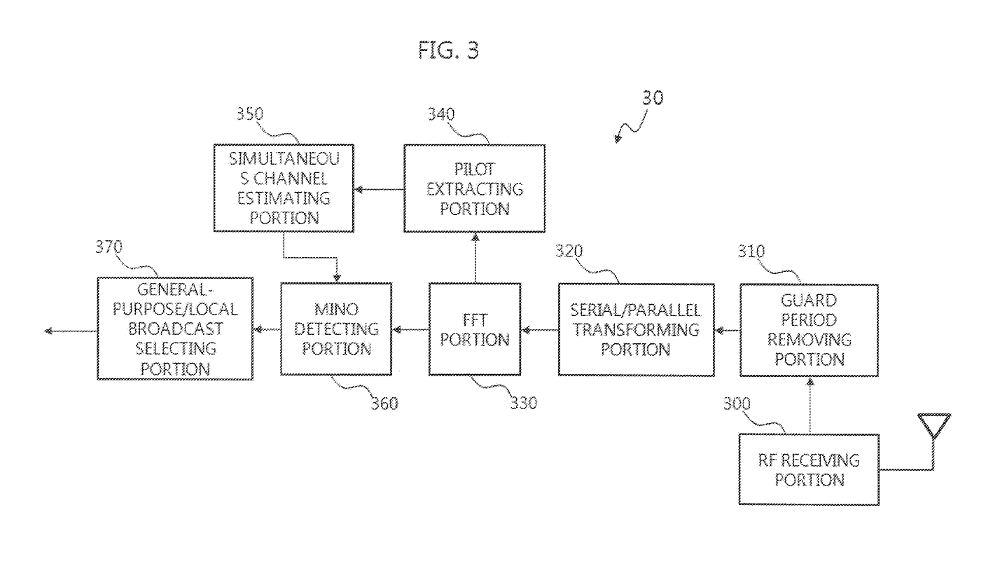

FIG. 3 is a block view showing a receiver of the digital broadcast system according to an example of the present invention.

Referring to FIG. 3, a digital broadcast receiver 30 includes a RF receiving portion 300 receiving the signal from many adjacent digital broadcast transmitter (for example, a service transmitter and adjacent transmitter), a guard period removing portion 310 removing a guard period from the received signal, a serial/parallel transforming portion 320 transforming the received signal into many paratactic subcarriers, a fast Fourier transforming portion 330 (hereinafter, refer to the FFT) applying a fast Fourier transformation to many paratactic subcarriers in the frequency domain, a pilot extracting portion 340 extracting the pilot from the signal transformed by the fast Fourier transformation, a simultaneous channel estimating portion 350, a MIMO detecting portion 360, and a general-purpose/local broadcast selecting portion 370.

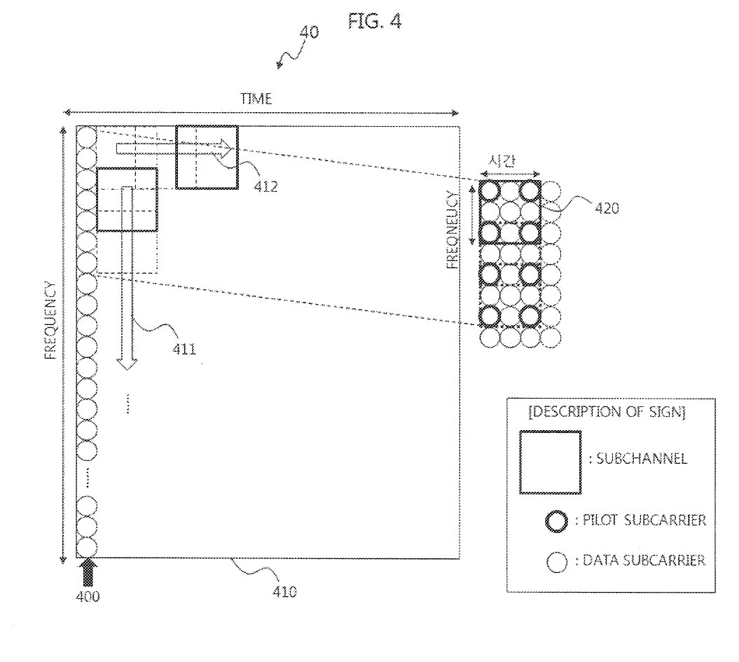

The simultaneous channel estimating portion 350 acquires time and frequency synchronization using a GPS (global positioning system) and/or a preamble 400 of a frame for digital broadcast shown in FIG. 4. This is because the time and frequency synchronization between the service transmitter and the adjacent transmitter should be performed in the receiver of the digital broadcast system based on the SFN. Referring to FIG. 4, a frame 40 includes a preamble 400, a data region 410 and subchannels 420. The data region 410 includes pilot subcarriers and data subcarriers in the frequency domain. The pilot subcarriers are subcarriers with a pilot signal, and the data subcarriers are subcarriers with data.

The simultaneous channel estimating portion 350 selects the size (time domain×frequency domain) of the subchannel 420, that is, the unit estimating the channels by it. For example, one subchannel 420 includes 3 subcarriers in the time domain and 3 subcarriers in the frequency domain, and is configured by total 9 subcarriers. Further, 4 pilot subcarriers are disposed at 4 apexes of the subchannels 420. However, this is an illustration only to easily describe the present embodiment, the subcarriers 420, according to the technical idea of the present invention, are not limited to the total number of the subcarriers, the number of the subcarriers in the time/frequency domain and the number and positions of the pilot subcarriers mentioned in FIG. 4. That is, the simultaneous channel estimating portion 350 is surely not limited to FIG. 4 on determining the size of the subchannel 420.

After determining the size of the subchannel 420, the simultaneous channel estimating portion 350 performs a simultaneous channel estimating process 411 for each subcarrier 420 in the frequency domain direction and a simultaneous channel estimating process 412 for each subcarrier 420 in the time domain direction, as shown in FIG. 4. On describing the simultaneous channel estimating processes 411 and 412, the following situations are assumed. First, after assuming the signal overlap region AB 130 in FIG. 1, it is assumed that the simultaneous channel estimating portion 350 selects the size of the subcarrier 420 as 4 pilot subcarriers. Further, it is assumed that the receiver 30 includes two receiving antennas (first and second receiving antennas).

On marking i-th pilot signal transmitted by the transmitter A 100 as P_{A,i}, marking i-th pilot signal transmitted by the transmitter B 110 as P_{B,i}, marking i-th pilot signal received by the first receiving antenna as r⁽¹⁾ᵢ, and marking noises that cause when the first receiving antenna receives the i-th pilot signal as n⁽¹⁾ᵢ, the following Equation is established.

rᵢ⁽¹⁾=h_{A,i}⁽¹⁾P_{A,i}+h_{B,i}⁽¹⁾P_{B,i}+nᵢ⁽¹⁾

rᵢ₊₁⁽¹⁾=h_{A,i+1}⁽¹⁾P_{A,i+1}+h_{B,i+1}⁽¹⁾P_{B,i+1}+nᵢ₊₁⁽¹⁾

rᵢ₊₂⁽¹⁾=h_{A,i+2}⁽¹⁾P_{A,i+2}+h_{B,i+2}⁽¹⁾P_{B,i+2}+nᵢ₊₂⁽¹⁾

rᵢ₊₃⁽¹⁾=h_{A,i+3}⁽¹⁾P_{A,i+3}+h_{B,i+3}⁽¹⁾P_{B,i+3}+nᵢ₊₃⁽¹⁾ [Equation 1]

Where, when the transmitter A 100 transmits the i-th pilot signal P_{A,i} to the first receiving antenna, h⁽¹⁾_{A,i} represents channel responses experienced by P_{A,i}. Further, when the transmitter B 110 transmits the i-th pilot signal P_{B,i} to the first receiving antenna, h⁽¹⁾_{B,i} represents the channel responses experienced by P_{B,i}.

The channel response h⁽¹⁾_{A,i} at the transmitter A 100 is common channel response values at the subchannel i including P_{A,i}, P_{A,i+1}, P_{A,i+2}, P_{A,i+3}. That is, the carriers in [time domain×frequency domain] of the subchannel 420 have the same channel responses from each other. Therefore, it is a lofty ideal that the simultaneous channel estimating portion 350 selects the region that does not generate channel change as the subchannel 420 at time and frequency periods. For example, the simultaneous channel estimating portion 350 selects the subchannels having time smaller than coherence time in the time domain, and selects the subchannels having frequency smaller than coherence frequency in the frequency domain.

As described above, the carriers in time domain×frequency domain of the subchannel 420 have the same channel responses from each other. Therefore, the Equation 1 above may be represented by matrix as the following Equation by the simultaneous channel estimation assuming that the channel responses for i-th, i+1-th, i+2-th and i+3-th pilots are the same from each other.

$$[ \begin{matrix}{r}_{i}^{( 1 )} \\ {r}_{i + 1}^{( 1 )} \\ {r}_{i + 2}^{( 1 )} \\ {r}_{i + 3}^{( 1 )}\end{matrix} ] = [ \begin{matrix}{P}_{A , i} & {P}_{B , i} \\ {P}_{A , i + 1} & {P}_{B , i + 1} \\ {P}_{A , i + 2} & {P}_{B , i + 2} \\ {P}_{A , i + 3} & {P}_{B , i + 3}\end{matrix} ] \cdot [ \begin{matrix}{h}_{A , i}^{( i )} \\ {h}_{B , i}^{( i )}\end{matrix} ] + [ \begin{matrix}{n}_{i}^{( 1 )} \\ {n}_{i + 1}^{( 1 )} \\ {n}_{i + 2}^{( 1 )} \\ {n}_{i + 3}^{( 1 )}\end{matrix} ] \qquad [ Equation 2 ]$$

According to the simultaneous channel estimation, the channel responses formed between the transmitter A 100 and the first receiving antenna or the transmitter B 110 and the first receiving antenna may be represented as follows.

H⁽¹⁾=pseudo_inv(P)·R⁽¹⁾=[(P^{T}P)⁻¹P^{T}]·R⁽¹⁾ [Equation 3]

Further, according to the simultaneous channel estimation, the channel responses formed between the transmitter A 100 and the second receiving antenna or the transmitter B 110 and the second receiving antenna may be represented as follows.

H⁽²⁾=pseudo_inv(P)·R⁽²⁾=[(P^{T}P)⁻¹P^{T}]·R⁽²⁾ [Equation 4]

In the Equation 3 and 4, R⁽¹⁾ is a vector of the signal received by the first receiving antenna, H⁽¹⁾ is a channel response matrix formed between the transmitter A 100 and the first receiving antenna or the transmitter B 110 and the first receiving antenna, and P⁽¹⁾ is a pilot matrix as the following Equation.

$$[ \begin{matrix}{P}_{A , i} & {P}_{B , i} \\ {P}_{A , i + 1} & {P}_{B , i + 1} \\ {P}_{A , i + 2} & {P}_{B , i + 2} \\ {P}_{A , i + 3} & {P}_{B , i + 3}\end{matrix} ] \qquad [ Equation 5 ]$$

The simultaneous channel estimating portion 350 acquires the channel response for each of the first receiving antenna and the second receiving antenna as the following Equations 6 and 7 by performing the simultaneous channel estimation using the Equations 1 to 5.

H⁽¹⁾=[h_{A,i}⁽¹⁾ h_{B,i}⁽¹⁾]^{T} [Equation 6]

H⁽²⁾=[h_{A,i}⁽²⁾ h_{B,i}⁽²⁾]^{T} [Equation 7]

When an inverse matrix of the matrix P is absent, the accuracy of the channel responses are lowered. To solve above problem, the simultaneous channel estimating portion 350 in the embodiment of the present invention overlappingly acquires the channel values of each subchannel, the channel period not having the inverse matrix is calculated by time and frequency interpolation, and the simultaneous channel estimating portion 350 equally applies this method to H⁽¹⁾=[h_{A,i}⁽¹⁾ h_{B,i}⁽¹⁾]^{T} and H⁽²⁾=[h_{A,i}⁽²⁾ h_{B,i}⁽²⁾]^{T}.

The MIMO detecting portion 360 separately detects each signal transmitted from the transmitter A 100 and the transmitter B 110 using a spatial multiplexing MIMO signal detection scheme based on each channel response acquired from above. At this time, the signal detected at the transmitter A 100 is marked as Ŝ_{A}, and the signal detected at the transmitter B 110 is marked as Ŝ_{B}.

The general-purpose/local broadcast selecting portion 370 combines Ŝ_{A} with Ŝ_{B} to output the general-purpose broadcast. Further, on outputting the local broadcast. The general-purpose/local broadcast selecting portion 370 compares strength of Ŝ_{A} with the strength of Ŝ_{B}, and selects the local broadcast at the transmitter sending strong signal. For example, when the signal at the transmitter is strong, the general-purpose/local broadcast selecting portion 370 selects Ŝ_{A} to output the local broadcast at the transmitter A 100. In addition, when the signal at the transmitter B 110 is strong, the general-purpose/local broadcast selecting portion 370 selects Ŝ_{B} to output the local broadcast at the transmitter B 110.

A signal overlap region AC 140, a signal overlap region BC 150 and a signal overlap region ABC 160 may detect the signal received by the same processes from each other.

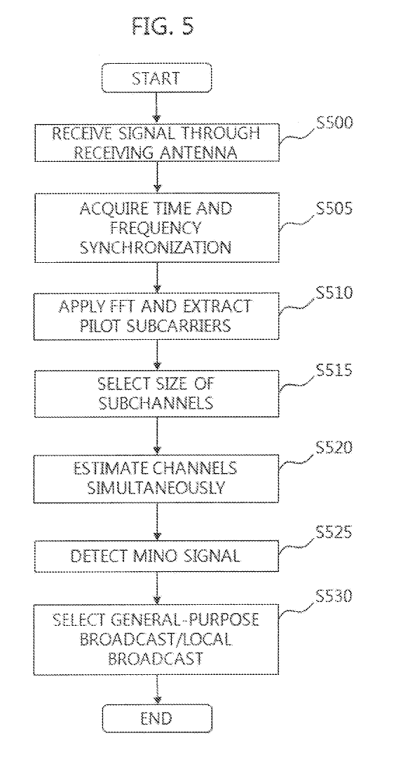

FIG. 5 is a flow chart showing the simultaneous channel estimating process and broadcast selecting process in the digital broadcast receiver according to an example of the present invention.

Referring to FIG. 5, the receiver 30 receives the signal transmitted through a plurality of receiving antennas from a plurality of transmitters (S500). The receiver 30 acquires the time and frequency synchronization using the GPS and/or the preamble 400 of the frame for the digital broadcast shown in FIG. 4. This is because the time and frequency synchronization between the service transmitter and the adjacent transmitter should be performed in the receiver of the digital broadcast system based on the SFN.

The receiver 30 applies the fast Fourier transform to many paratactic subcarriers in the frequency domain, and extracts the pilot from the transformed signal (S510).

The receiver 30 selects the size (time domain×frequency domain) of the subchannels 420, that is, the unit estimating the channel by it (S515). For example, one subchannel 420 includes 3 subcarriers in the time domain and 3 subcarriers in the frequency domain, and is configured by total 9 subcarriers. Further, 4 pilot subcarriers are disposed at 4 apexes of the subcarriers 420. However, this is an illustration only to easily describe the present embodiment, the subcarriers 420, according to the technical idea of the present invention, are not limited to the total number of the subcarriers, the number of the subcarriers in the time/frequency domain and the number and positions of the pilot subcarriers mentioned in FIG. 4. That is, the simultaneous channel estimating portion 350 is surely not limited to FIG. 4 on determining the size of the subchannel 420.

After determining the size of the subchannel 420, the receiver 30 performs the simultaneous channel estimating process 411 for each subcarrier 420 in the frequency domain direction and the simultaneous channel estimating process 412 for each subcarrier 420 in the time domain direction, as shown in FIG. 4 (S520). For example, the receiver 30 acquires the channel responses for the first receiving antenna and the second receiving antenna as the Equations 6 and 7 above by performing the simultaneous channel estimation using the Equations 1 to 5. On the other hand, when the inverse matrix of the matrix P is absent, the accuracy of the channel responses may be lowered. To solve above problem, the receiver 30 overlappingly acquires the channel values of each subchannel, the channel period not having the inverse matrix is calculated by time and frequency interpolation.

The receiver 30 detects each signal transmitted from each the transmitter using the spatial multiplexing MIMO signal detection scheme based on each channel response acquired from above. At this time, the receiver 30 combines the signals detected at each transmitter to output the general-purpose broadcast. Further, on outputting the local broadcast, the receiver 30 compares the strengths of the signals at each transmitter, and selects the local broadcast at the transmitter sending strong signal.

According to an embodiment of the present invention, the receiving apparatus in the single frequency network may simultaneously estimate the channels of adjacent transmitters, and detects MIMO signal by the estimated channel, thereby to enhance carrier to noise ratio (CNR) to be received. Further, the receiving apparatus may receive the local broadcast provided on the sidelines of the general-purpose broadcast by each of the adjacent transmitters.

The spirit of the present invention has been just exemplified. It will be appreciated by those skilled in the art that various modifications and alterations can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A receiver for selecting a general-purpose broadcast and local broadcast in a digital broadcast system based on a single frequency network, comprising:
a RF receiving portion configured to receive at least one signals transmitted by at least one transmitter;
a guard period removing portion configured to remove a guard period from the receiving signal inputted from the RF receiving portion;
a serial/parallel transforming portion configured to transform the received signal into many paratactic subcarriers;
a fast Fourier transforming portion configured to apply a fast Fourier transformation to the many paratactic subcarriers in the frequency domain;
a pilot extracting portion configured to extract pilots from the signal transformed by the fast Fourier transform; and
a general-purpose/local broadcast selecting portion configured to combine the at least one signal to output the general-purpose broadcast, and selecting any one of the at least one signal to output the local broadcast.

2. The receiver of claim 1, further comprising:
a simultaneous channel estimating portion configured to simultaneously acquire channel responses for each subchannel including a certain number of pilot subcarriers in the frequency and time domain direction from frames transmitted with the at least one signal.

3. The receiver of claim 2, wherein the simultaneous channel estimating portion acquires the channel responses for each of a plurality of receiving antennas disposed in the receiver, and
further comprising a MIMO detecting portion separately detecting the at least one signals using a spatial multiplexing MIMO signal detection scheme based on the channel responses for each of the plurality of receiving antennas.

4. The receiver of claim 2, wherein the simultaneous channel estimating portion selects the subchannels having time smaller than coherence time in the time domain, and selects the subchannels having frequency smaller than coherence frequency in the frequency domain.

5. The receiver of claim 2, wherein the channel responses are represented as a channel matrix configured with the channels experienced by the pilots included in the subchannels, and
when an inverse matrix for the channel matrix is absent, the simultaneous channel estimating portion acquires the channel responses by time and frequency interpolation.

6. A method for selecting a general-purpose broadcast and a local broadcast by a receiver in a digital broadcast system based on a single frequency network, comprising:
receiving at least one signals transmitted by at least one transmitter;
removing a guard period from the receiving signal inputted from the RF receiving portion;
transforming the received signal into many paratactic subcarriers;
applying a fast Fourier transform to the many paratactic subcarriers in the frequency domain;
extracting the pilots from the signal transformed by the fast Fourier transform; and
combining the at least one signal to output the general-purpose broadcast, and selecting any one of the at least one signal to output the local broadcast.

7. The method of claim 6, further comprising:
acquiring channel responses simultaneously for each subchannel including a certain number of pilot subcarriers in the frequency and time domain direction from frames transmitted with the at least one signal.

8. The method of claim 7, wherein the channel responses are the channel responses for each of a plurality of receiving antennas disposed in the receiver, and
further comprising separately detecting the at least one signals using a spatial multiplexing MIMO signal detection scheme based on the channel responses for each of the plurality of receiving antennas.

9. The method of claim 7, further comprising selecting the subchannels having time smaller than coherence time in the time domain, and selecting the subchannels having frequency smaller than coherence frequency in the frequency domain.

10. The method of claim 7, wherein the channel responses are represented as a channel matrix configured with the channels experienced by the pilots included in the subchannels, and
when an inverse matrix for the channel matrix is absent, the simultaneous channel estimating portion acquires the channel responses by time and frequency interpolation.
